(19) United States
(12) Patent Application Publication
(10) Pub. No.: US 2006/0067545 A1
(43) Pub. Date: Mar. 30, 2006

(54) Device for encouraging hand wash compliance

(75) Inventors: Richard P. Lewis, Marietta, GA (US); Paul F. Tramontina, Alpharetta, GA (US); Kenneth Kaufman, Bradenton, FL (US); Cheryl L. York, Canton, GA (US)

Correspondence Address: DORITY & MANNING, P.A., POST OFFICE BOX 1449, GREENVILLE, SC, 29602-1449, US

(73) Assignee: KIMBERLY-CLARK WORLDWIDE, INC.

(21) Appl. No.: 10/950,965

(22) Filed: Sep. 27, 2004

(51) Int. Cl. G09F 27/00; G08B 23/00

(52) U.S. Cl. 381/124; 340/573.1; 381/334

(57) ABSTRACT

A device to encourage hand washing compliance in a facility such as a restroom includes a housing configured for detachably mounting on a support surface. An ambient light sensor is disposed relative to the housing to detect ambient light within the room. An audio device within the housing contains at least one audible hand washing compliance message track that is played over a speaker within the housing. A controller is in operable communication with the ambient light sensor and the audio device, and activates the device upon determining whether a threshold amount of ambient light is present in the room.

### FIELD OF THE INVENTION

The present invention relates generally to the field of devices or systems that automatically play a recorded message upon occurrence of a detected event, and particularly to devices that automatically encourage users to wash their hands.

### BACKGROUND OF THE INVENTION

The importance of washing ones hands after using a restroom, particularly public restrooms, is well understood and appreciated by medical and food handling industries, and the general public as a whole, for preventing the spread of illness and maintaining personal hygiene and cleanliness. Many diseases have been found to be transmittable due to non-compliance with proper hand washing techniques after using public toilet facilities. In the food service sector, it is required by law in many states that employees wash their hands prior to returning to work after use of a toilet facility.

For these reasons, the use of signs and placards containing written notices and messages to encourage persons to wash their hands is widespread. Unfortunately, such signs have become so commonplace that their existence is barely noticed and they are relatively ineffective in encouraging people to actually wash their hands. These signs go generally unheeded by the public.

Efforts have been made at devising more aggressive systems to encourage people to wash their hands. For example, U.S. Pat. No. 6,031,461 describes a system wherein the user of a toilet is automatically marked with a washable substance such as a dye, paint, or chalk, upon flushing the toilet. The person must then thoroughly wash their hands to remove the substance. This type of system will irritate many individuals and would be prone to vandalism in public restrooms.

U.S. Pat. Nos. 5,870,015 and 6,028,520 describe different audible message systems that are automatically actuated by sensing operation of the toilet. The systems require sensors of one type or another to be configured with each individual toilet, such sensors being in communication with a controller that plays a prerecorded message upon, for example, sensing that the toilet has been flushed. These type of systems are relatively complex in that each toilet must be configured with at least one sensor and the controller must be sophisticated enough to receive and process signals from numerous sources. Also, the sensors are generally visible to the person using the toilet and, thus, prone to abuse.

Other systems require the user to wear an indicator or badge that is activated if the person has not washed their hands at a required location. The badge gives an outwardly visible indication that the person has not complied with required hand washing techniques. Reference is made for example to U.S. Pat. Nos. 5,812,059 and 5,610,589. Such systems are obviously not suitable for general public restroom facilities.

U.S. Pat. No. 4,896,144 describes an audible or visible message system that is actuated upon opening a door to a restroom facility. The system may also be configured to lock the restroom door to prevent the person from leaving the facility until they have complied, or to issue a warning signal to a remote location.

There is still need in the industry for a relatively simple, inexpensive, and non-obtrusive device to encourage users of public restroom facilities to wash their hands.

### OBJECTS AND SUMMARY OF THE INVENTION

Objects and advantages of the invention will be set forth in part in the following description, or may be obvious from the description, or may be learned through practice of the invention.

The present invention relates to a device intended to encourage persons entering a room or facility to wash their hands. The device has particular use in public restrooms, but is in no way limited to such use. The device may be located in any room or facility wherein persons should wash their hands or perform some other desired or required function after or before performing an activity. For example, the device may be used in medical facilities, research labs, clean room manufacturing facilities, and so forth.

The device includes a housing having any manner of aesthetically pleasing shape and that is configured for detachably mounting on a support surface such as a wall, counter, cabinet, and so forth. Any number of mechanical or adhesive mounting devices may be used in this regard. The housing may include a base and a cover, the cover being removable from the base to provide access to internal components of the device and a battery compartment (if provided).

The device includes a sensor for detecting the amount of ambient light within the room where the device is located. This sensor may include, for example, an array of one or more photodiodes. The photodiodes may be calibrated to react to only a threshold amount of ambient light within the room. In this regard, it may be desired to locate the photodiodes relative to the housing such that their sensing direction is relatively unaffected by persons or events in the room. For example, the sensor may be disposed to “look” through a lens in a top portion of the housing towards the ceiling of the room. The ambient light sensor may also be located remote from the housing. In a particular embodiment, the photodiode generates an input signal to a control circuit, for example as an input to a microprocessor, to initiate playback of a message upon sufficient ambient light being detected. The ambient light sensor may also be used to initiate a reduced power mode for the internal control circuitry in the absence of a threshold level of ambient light in order to prolong battery life.

An audio storage/playback device within the housing contains one or more pre-recorded audible hand washing compliance message tracks. The storage device may be any conventional device, such as a tape device, CD player, an electronic storage or “voice” chip, such as a permanently programmed ROM chip or programmable RAM chip. Various such devices are well known in the art, and the present device is not limited to any particular type of storage or playback device. A speaker within the housing is in operable communication with the audio device for playback of the message track.

The audio device may be programmable by a maintenance technician or other individual for customized voice messages. For example, an internal microphone may be incorporated to allow direct input of a voice message. Other means to customize the messages include, for example, RF devices, hard wire input hook-ups, text-to-voice via a computer, hand held devices that mate with the device, and so forth. In an alternative embodiment, the message may be permanently preprogrammed onto a storage medium in the device.

A control circuit activates the audio device upon sufficient ambient light being detected in the room. The control circuit may include a programmable microprocessor for controlling the various functions of the device, or in a less complicated embodiment, the control circuit may be a hard wired integrated circuit board type of controller. The control circuit may be configured to simply play the message track according to a timed sequence so long as a signal from the photodiode indicates that sufficient ambient light is present. For example, the circuit may include an internal timing loop such that the message(s) are repeated with a desired “dwell” time between each message (i.e., a 30 second dwell time). In an alternate embodiment, an adjustment switch may be provided to vary the dwell time.

The device may also include a master switch that de-energizes the control circuit regardless of the amount of ambient light within the room. This switch is preferably conspicuously located on or within the housing, or requires a special tool to access or position the switch.

The device may be portable and battery powered, wherein a battery compartment is provided within the housing and is accessible by removing a cover from the housing. In an alternate embodiment, the device may be powered by an existing AC system and include an appropriate transformer. With this embodiment, the device may be permanently mounted and hard-wired into the facilitiy's AC power system. In still an alternate embodiment, the device may be configured for both AC and battery DC power. A switch may be provided to select between power sources, or the control circuit may be configured to detect whether AC power is available and automatically switch to AC power. Various power schemes may be used in this regard, and the present invention is not limited to any particular type of power distribution scheme.

The message tracks may be widely varied. In a relatively simple embodiment, a single message track is stored in the audio device and contains a single message that is repeated (with or without an appreciable dwell time) so long as sufficient ambient light is detected by the ambient light sensor. In an alternative embodiment, the message track may contain multiple messages that are played back in sequence. For example, the track may contain the message but in different languages. Alternately, the message track may contain messages of different content in the same or different languages.

In a particularly versatile embodiment, multiple message tracks are stored in the audio device and a selector switch is provided to select between the different message tracks. For example, one message track may contain one or more messages particularly suited for a female restroom, and a separate message track may contain one or more messages particularly suited for a male restroom. In another embodiment, one message track may contain one or more messages that politely remind users to wash their hands, and a separate message track may contain messages of a more aggressive or forceful nature. It should be appreciated that the content and intent of different message tracks may be widely varied within the scope and spirit of the invention.

As mentioned, in a more sophisticated embodiment, the control circuit may include a microprocessor that performs various control functions. For example, the microprocessor may include an internal clock and be programmed to sample and process the ambient light signal from the photodiode at a certain frequency determined by the clock. The ambient light signal is compared to a stored threshold value and the device is actuated by the microprocessor if the actual ambient light exceeds the threshold value. The microprocessor may be programmable so that various functions and the message tracks can be changed. The microprocessor may be programmed to switch between different message tracks, or messages within an individual track, according to a programmed sequence or at random. It should be appreciated that a microprocessor will allow for a great number of control features that are within the scope and spirit of the invention.

It may also be desirable to include any number of shutdown or hibernation features with the device. For example, even if a threshold amount of ambient light is present, it may not be desired for the device to play continuously. A “rest” period may be programmed into the controls so that the device plays for a certain period of time and is deactivated for a period of time.

The invention will be described in greater detail below by reference to one or more embodiments illustrated in the accompanying drawings.

### BRIEF DESCRIPTION OF THE DRAWINGS

FIG. 1 is a perspective view of an exemplary restroom facility utilizing an device according to the present invention;

FIG. 2 is a side perspective view of an embodiment of the device according to the invention;

FIG. 3 is a perspective view of the device of FIG. 2 with the cover removed;

FIG. 4 is a perspective view of an exemplary control circuit board that may be used with the device of the present invention; and

FIG. 5 is a diagram of an exemplary control circuit for use with the device.

### DETAILED DESCRIPTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment, may be used with another embodiment, to yield still a further embodiment. It is intended that the present invention include modifications and variations to the embodiments described herein.

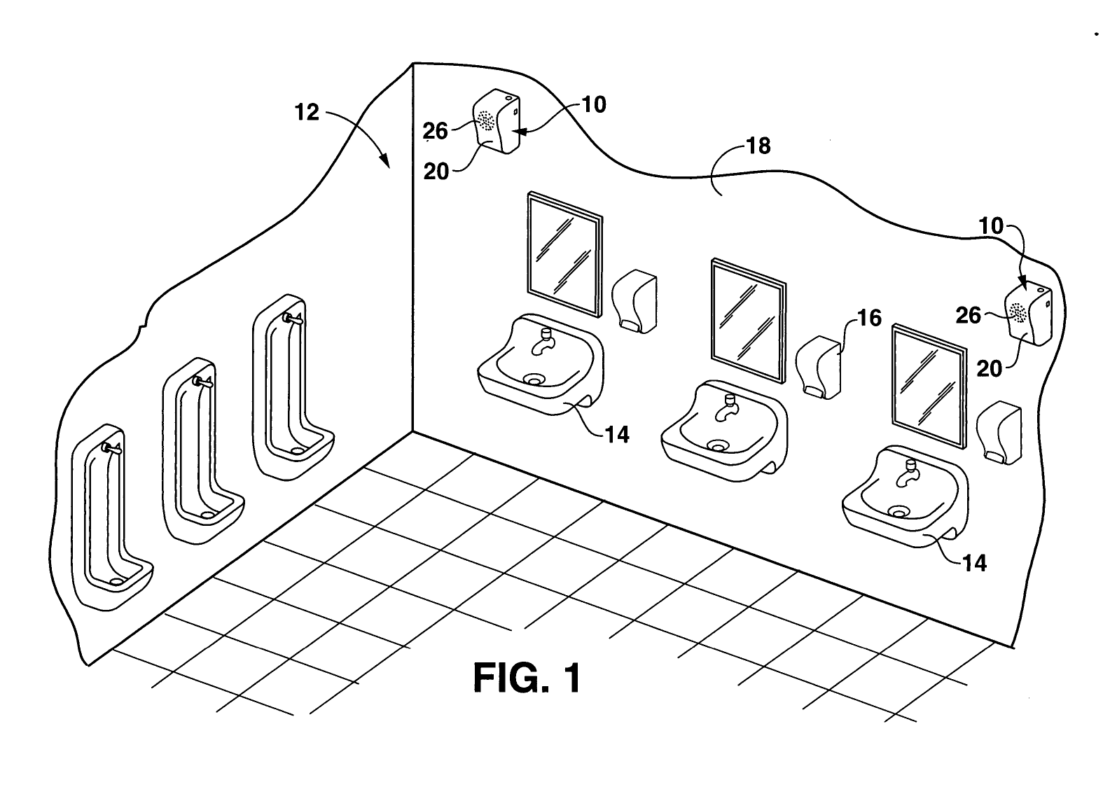

An embodiment of a device according to the invention for encouraging persons entering a room or facility to wash their hands is depicted generally as reference numeral 10 in the figures. Referring to FIG. 1, the device 10 is particularly useful in public restroom facilities 12 wherein hand washing stations including basins 14 and soap dispensers 16 are provided for persons to wash their hands after using the facilities. The device 10 is mounted at a suitable location on a support surface 18, such as a wall, counter, cabinet, and so forth. The device may be mounted by any conventional means, such as an adhesive, mechanical attaching devices, and so forth. Desirably, the device 10 is strategically mounted at a location within the facility 12 so as to be heard by persons using the facility. It may be desired to locate the device 10 at a height and location within the room 12 to deter vandalism. This may be accomplished simply by mounting the device 10 near the ceiling of the room 12.

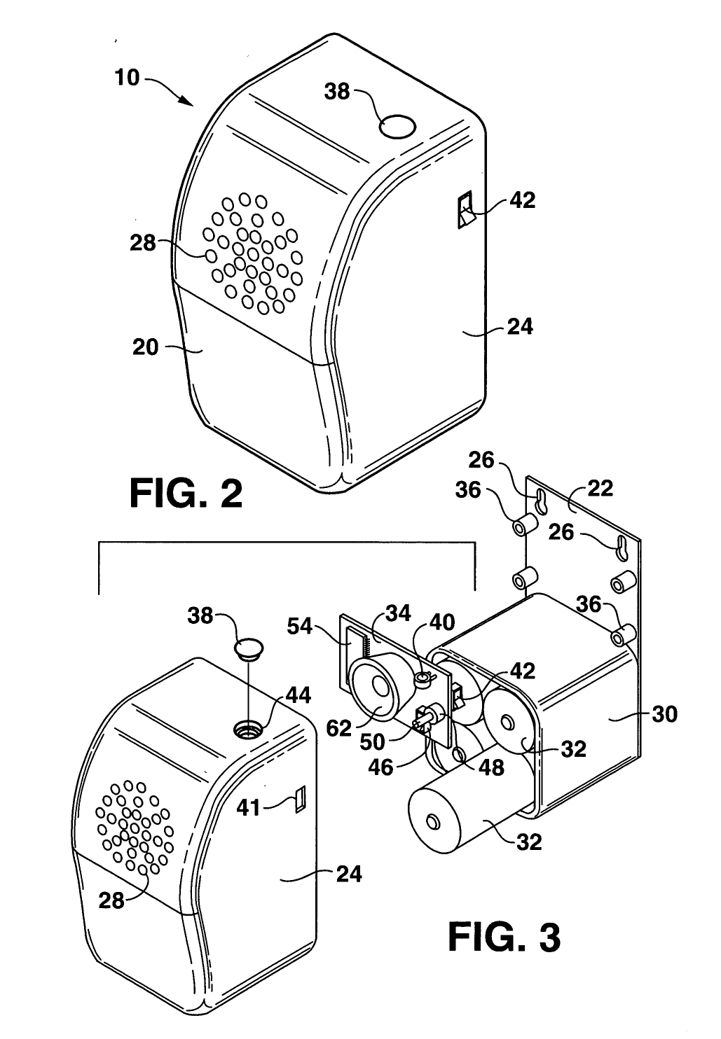

The device 10 includes a housing, generally 20, that may have any aesthetically pleasing shape and configuration, and may be made of any combination of conventional materials. Referring particularly to FIGS. 2 and 3, the housing 20 may include a base member 22 and a removable cover member 24. The base member 22 may include mounting holes 26, or any other suitable device or mechanism for mounting the housing 20 to the support surface, such as the wall 18 within the facility 12. The cover 24 is preferably removable from the base 22 in order to provide access to the internal components of the device 10. The cover 24 may be detachedly secured to the base 22 by any conventional means, including a latch mechanism, friction fit, detent mechanism, and so forth.

The cover 24 may include an array of holes 28 defined in an aesthetically pleasing pattern. The array 28 is located so that an audible message from a speaker 62 may be conveyed into the room 12 through the cover 24. In an alternate embodiment, a separate screen, wire grid, or other type of suitable speaker cover may be incorporated into the removable cover 24.

The device 10 includes a sensor for detecting the level of ambient light within the room or facility 12. In the illustrated embodiment, the ambient light sensor is at least on photodiode 40 (and may include an array of the photodiodes 40) disposed within the housing 20. The photodiode 40 detects ambient light through a lens 38 fitted into an opening 44 in the housing cover 24. Desirably, the photodiode 40 and associated lens 38 are positioned to detect the level of ambient light within the room 12 that is unaffected by persons or activity occurring within the room 12. For example, it would be undesirable for the amount of ambient light detected by the sensor 40 to vary by the number of persons or position of such persons within the room 12. Thus, in the illustrated embodiment, the detector 40 is oriented so as to “look” through the top portion of the removable cover 24 towards the ceiling of the facility 12.

The use of photodiodes in sensor systems to detect ambient light is well known by those skilled in the art and a detailed explanation of such devices is not necessary for purposes of the present description.

In an alternative embodiment not illustrated in the figures, the ambient light sensor may be a remotely located sensor. For example, one or an array of photodiodes may be remotely located with respect to the housing and in communication with control circuitry of the device 10 for conveying an ambient light signal to the circuitry. For example, the photodiode may be a plug-in component to the control circuitry board.

The photodiode 40 may be calibrated to react only to a threshold amount of ambient light within the room 12. In an alternate embodiment, the photodiode may transmit a signal indicative of any amount of ambient light detected within the room 12, this signal being compared by the control circuitry to a predetermined threshold value and, if the threshold value is exceeded the control circuitry will initiate playback of the stored audio message.

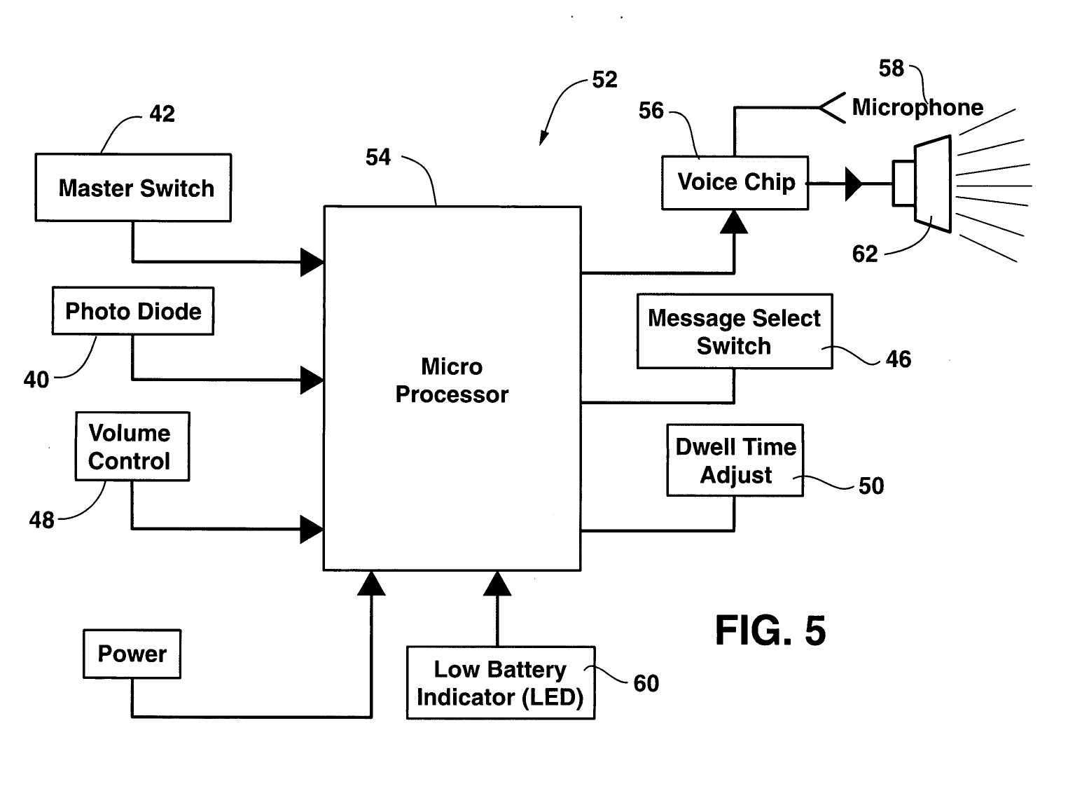

An audio storage/playback device is contained within the housing for storing one or more prerecorded audible hand washing compliance message tracks. The device 10 is not limited by any particular type of audio device. For example, such device may be a conventional tape device, CD player/recorder, and the like. In a particularly desirable embodiment, the audio device comprises an electronic storage “voice” chip 56 (FIG. 5). Any one or combination of hand washing messages are encoded in the chip 56 and are transmitted to a speaker 62 (with associated speaker driver) for subsequent delivery as an audible hand washing compliance message to persons within the facility 12. Such messages will be described in greater detail below.

In a particular embodiment, the voice chip 56 may be a ROM version that is pre-programmed at the point of manufacture of the device 10 with the desired message track(s). With this embodiment, the messages are permanently stored and cannot be altered. In an alternative embodiment, the voice chip 56 may be a RAM version and the control circuitry 52 (FIG. 5) may include a microphone 58 for customization and programmability of the RAM voice chip 56. Suitable voice chip audio devices include the ISD1020A device commercially available from Information Storage Devices, Inc. With this embodiment, the customization or recording of any number of voice messages is accomplished by the end user recording a personalized message via the microphone 58 and under the control of a microprocessor 54. The microphone 58 may be mounted within the housing 20 so as to be operationally accessible through the speaker hole array 28 in the cover 24. This message customization feature provides distinct advantages for enhancing the versatility and functionality of the device 10.

The device 10 also includes a control circuit for initiating and controlling playback of the stored message or messages. The control circuit components may be mounted to a circuit board 34 contained in the housing 20. In the illustrated embodiment, the circuit board 34 is mounted to the base 22 by way of mounting posts 36. In one embodiment, the control circuit need not include a microprocessor, but may include a hard wired integrated circuit wherein the control functions are executed by conventional logic circuits and chip devices. For example, such a control circuit may include an audio circuit incorporated as a single chip voice record/playback device, such as an ISD2560S device, or the VP1000 Quick Voice Device manufactured by Eletech Electronics, Inc. The audio device is actuated upon receipt of a control signal from the ambient light sensor (after appropriate filtering, amplification, and so forth).

In a particularly functional embodiment, the control circuitry 52 (FIG. 5) includes a programmable microprocessor 54. This microprocessor 54 may be, for example, a Microchip PIC16C505 device or PIC165C56 device commercially available from Microchip Technology, Inc. The microprocessor 54 responds directly to electrical or mechanical switch inputs from the various devices, as illustrated in FIG. 5 and explained in greater detail below. The microprocessor 54 can directly drive outputs, such as the voice chip 56 and speaker/speaker drive combination 62. A power amplifier may be added to enhance of the output functions of the microprocessor 54.

The microprocessor 54 includes any number of programmable I/O pins for additional functionality. For example, these pins may be used to provide selectability between various message tracks, as indicated by the message select switch 46 in FIG. 5. The microprocessor 54 may allow for manual adjustment of the dwell time between messages, as provided by the dwell time adjust mechanism 50. Similarly, a volume control device 48 may provide an input to the microprocessor 54 for adjusting the volume of the audio message.

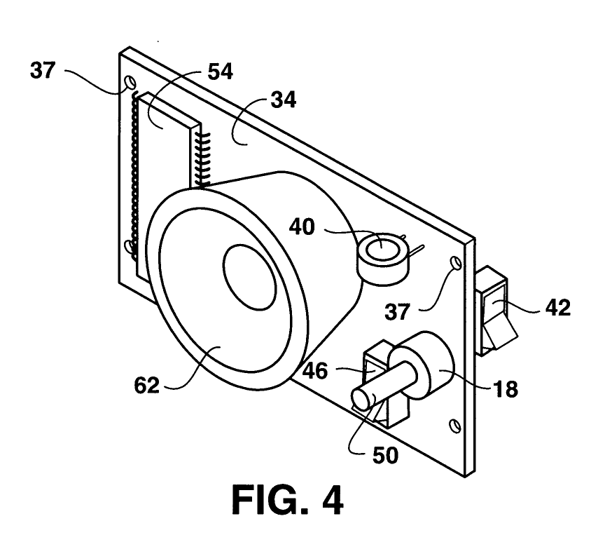

Referring particularly to FIGS. 2 through 5, the device 10 may include a master switch 42 that is accessible through an opening 41 in the housing cover 24. This switch may be conveniently located so that a maintenance technician can de-energize the device 10 regardless of the amount of ambient light within the room. The switch 42 may desirably be conspicuously located within the housing 20 so as to be unnoticeable or generally inaccessible by the public. For example, the switch 42 may be recessed within the housing and accessible via a special tool or other device inserted through the opening 41 in the housing cover 24. This configuration prevents unauthorized deactivation of the device.

The device 10 may be powered by any configuration of AC or DC power supply. For example, in the illustrated embodiment, the device 10 is generally portable and includes an internal battery compartment 30 in which batteries 32 are housed. The batteries 32 provide the power supply to the control circuitry, as illustrated in FIG. 5. In an alternative embodiment, the device 10 may be supplied by a facility's existing AC system. For example, the device 10 may be hardwired to the AC system and include an internal or external transformer to provide the necessary DC voltage for the control circuitry 52. In still an alternative embodiment, the device 10 may be configured to be supplied with DC power from an internal DC power source, such as the batteries 32, or via external AC power. A switch (not illustrated) may be provided to select between the desired power source.

A voltage detection circuit 60 may also be desired for detecting and providing an indication of low battery power. For example, the circuit may illuminate a visible LED in the event that battery power falls below a given voltage level.

As mentioned, the stored message tracks may vary considerably within the scope and spirit of the invention. The voice message can be of an animated character, a celebrity, in different languages, and so forth. The messages may be played by the microprocessor 54 according to a preprogrammed sequence, by random selection, and so forth. In this regard, the voice chip 56 has sufficient ROM or RAM memory for multiple messages, such messages being preprogrammed into a ROM memory or customized to a RAM memory. In a relatively simple embodiment of the invention, a single message track is stored on the voice chip 56 and is continuously repeated (with a selected dwell time between each message) so long as sufficient ambient light is detected by the photodiode 40. In an alternate embodiment, the message track may contain multiple messages that are played back in an alternating sequence. For example, a single message track may contain the same message in different languages. Alternately, a single message track may contain messages of different content in the same or different languages.

As mentioned, in a particularly versatile embodiment of the invention, multiple message tracks are stored on the voice chip 56 and accessible by the microprocessor 54. As mentioned, the message select switch 46 is provided so that a maintenance technician can select between desired message tracks. For example, one message track may contain one or more messages particularly suited for a female restroom, and a separate message track may contain one or more messages particularly suited for a male restroom. One message track may contain one or more messages that politely remind users to wash their hands, while a separate message track may contain one or more messages of a more aggressive or forceful nature. It should be appreciated that the content and intent of different message tracks may be widely varied within the scope and spirit of the invention.

It may be desired that the control circuitry 52 include an internal clock that may be utilized for various control functions. For example, the microprocessor 54 may sample the ambient light signal from the photodiode 40 at a frequency determined by the internal clock. The light signal may be compared to a stored threshold value and the device 10 being activated by the microprocessor 54 so long as the sampled ambient light signal exceeds the stored threshold value. This threshold value may be permanently programmed or stored in the microprocessor 54, or may be variable by a maintenance technician via an input to the microprocessor 54.

The message select switch 46 may also be configured to provide additional functionality to the sequence, number, and combination of messages stored in the voice chip 56. For example, the microprocessor may be programmed or programmable to switch between different message tracks, or messages within an individual message track, according to a programmed sequence, or in a random sequence. It should be appreciated that the microprocessor 54 allows for any combination of desirable functionalities within the scope and spirit of the invention.

The internal clock function described above may also be used to program a shutdown or hibernation feature for the device. For example, it may not be desired for the device 10 to continuously play a message in all situations where ambient light is present. In this regard, a “rest” period may be programmed into the circuitry 52 so that the device plays for a certain period of time and is deactivated for a remaining period of time. This may be the case, for example, wherein the device 10 is situated in a room or facility wherein ambient light is always present, but where it is not anticipated that users will be in the facility during certain times of the day.

It should be appreciated by those skilled in the art that various modifications and variations can be made to the embodiments of the device described herein without departing from the scope and spirit of the invention. It is intended that the invention include these and other modifications and variations as come within the scope of the appended claims and their equivalents.

What is claimed is:

1. A device to encourage hand washing compliance in a restroom, comprising:
a housing configured for detachably mounting on a support surface of a restroom;
an ambient light sensor disposed relative to said housing to detect ambient light within the restroom;
an audio device within said housing, said audio device containing at least one audible hand washing compliance message track;
a speaker within said housing, said speaker in communication with said audio device;
a control circuit in operable communication with said ambient light sensor and said audio storage device, said control circuit initiating playing of the hand wash compliance message over said speaker in a repeating timed cycle when a threshold amount of ambient light is present in the restroom and detected by said ambient light sensor.

2. The device as in claim 1, further comprising a master switch that deenergizes said device regardless of ambient light within the restroom.

3. The device as in claim 1, wherein said device is battery powered and further comprises a battery compartment within said housing.

4. The device as in claim 1, wherein said audio device stores a plurality of audible message tracks, and further comprising a selector switch in communication with said control circuit so that a desired one of said message tracks is selectable for playback.

5. The device as in claim 4, wherein each said message track contains multiple messages.

6. The device as in claim 1, wherein said message track contains a single message.

7. The device as in claim 1, wherein said message track contains multiple messages.

8. The device as in claim 1, wherein said ambient light sensor is a photodiode.

9. The device as in claim 1, wherein said control circuit comprises a microprocessor.

10. The device as in claim 9, wherein said audio device comprises an electronic storage chip, said message track retrieved from said storage chips via said microprocessor.

11. The device as in claim 10, wherein said message track is preprogrammed and permanently stored on said storage chip.

12. The device as in claim 10, wherein said message track is programmable via said microprocessor for customization by a user of said device.

13. The device as in claim 1, further comprising an adjustment switch to adjust dwell time between messages on said message track.

14. The device as in claim 1, wherein said control circuit shuts down said device after a predetermined time period of playing said message track.

15. The device as in claim 1, wherein said control circuit comprises a programmable microprocessor and said message track contains a plurality of different messages, said microprocessor playing said messages according to a preprogrammed sequence.

16. The device as in claim 15, wherein said sequence is random.

17. The device as in claim 1, wherein said ambient light sensor is disposed to look out through said housing in a direction in the restroom wherein ambient light can generally not be disrupted by persons in the restroom.

18. A device to encourage hand washing compliance, comprising:
a housing configured for detachably mounting on a support surface;
an ambient light sensor disposed relative to said housing to detect ambient light incident on said housing;
an audio device within said housing, said audio device containing multiple audible hand washing compliance message tracks;
a speaker within said housing, said speaker in communication with said audio storage device;
a microprocessor controller in operable communication with said ambient light sensor and said audio device, said controller programmed to play at least one of said message tracks in a repeating pattern upon determining whether a threshold amount of ambient light is incident on said housing.

19. The device as in claim 18, further comprising a selector device to switch between said message tracks to be played by said device.

20. The device as in claim 18, wherein each said message track comprises multiple different messages.

21. The device as in claim 18, further comprising an adjuster that varies a dwell time between played messages.

22. The device as in claim 18, wherein said microprocessor controller is programmable and said message track is changeable via said microprocessor.

23. The device as in claim 18, wherein said microprocessor controller is programmed to switch to a shut down mode after a predetermined time period of playing said message track.
